(19) United States
(12) Patent Application Publication
(10) Pub. No.: US 2016/0230850 A1
(43) Pub. Date: Aug. 11, 2016

(54) POWER TRANSMITTING APPARATUS FOR HYBRID VEHICLE

(71) Applicant: TOYOTA JIDOSHA KABUSHIKI KAISHA, Toyota-shi, Aichi-ken (JP)

(72) Inventors: Toshiki KANADA, Anjo-shi (JP); Ryuji IBARAKI, Miyoshi-shi (JP); Yuji YASUDA, Miyoshi-shi (JP); Atsushi TABATA, Okazaki-shi (JP); Tatsuya IMAMURA, Okazaki-shi (JP)

(73) Assignee: TOYOTA JIDOSHA KABUSHIKI KAISHA, Toyota-shi, Aichi-ken (JP)

(21) Appl. No.: 15/021,477

(22) PCT Filed: Sep. 11, 2014
(86) PCT No.: PCT/IB2014/001786

§ 371 Date: Mar. 11, 2016

(30) Foreign Application Priority Data
Sep. 13, 2013 (JP) 2013-190959

(51) Int. Cl. F16H 3/72; B60K 6/387; B60K 6/365; F16H 61/02; B60K 6/54

(52) U.S. Cl. CPC F16H 3/724; F16H 61/0265; B60K 6/54; B60K 6/365; B60K 6/387; F16H 2061/0046

(57) ABSTRACT

In a power transmitting apparatus for a hybrid vehicle, including a power split mechanism that splits or combines dynamic power and transmits the power between an engine and a drive shaft, and a transmission gear mechanism that changes a rotational speed of the engine through engagement and release of a clutch and a brake using hydraulic actuators, the transmission gear mechanism is formed as a transmission gear unit covered with a front cover and a rotary machine cover, and the transmission gear unit is mounted to a housing in which the power split mechanism and a motor-generator are disposed, while oil passages for shift control used for supplying hydraulic pressure to the hydraulic actuators are formed in the front cover or the rotary machine cover.

### BACKGROUND OF THE INVENTION

1. Field of the Invention

The invention relates to a power transmitting apparatus on which a hybrid vehicle including two or more sources of driving force having different dynamic power generation principles is installed.

2. Description of Related Art

A hybrid vehicle includes two or more driving sources having difference dynamic power generation principles, as sources of driving force for traveling the vehicle. The driving sources include, for example, an engine that generates dynamic power by converting thermal energy to kinetic energy, and a rotary machine (e. g., electric motor) having an energy regeneration capability. For example, an internal combustion engine, such as a gasoline engine or a diesel engine, and a rotary machine, such as an electric motor that functions as a generator, or a hydraulic motor that functions as an accumulator, may be installed on the hybrid vehicle. By utilizing respective characteristics possessed by the engine and the rotary machine, it is possible to improve the energy efficiency and reduce exhaust gas or emissions. One example of hybrid drive system for use in this type of hybrid vehicle is described in Japanese Patent Application Publication No. 2008-120234 (JP 2008-120234 A).

The hybrid drive system described in JP 2008-120234 A includes an engine, a first motor having a function of generating electric power using dynamic power of the engine, and a second motor that generates dynamic power to an output member using the electric power generated by the first motor. The first motor and the second motor are disposed on the same axis, and a power split mechanism that distributes the dynamic power generated by the engine to the first motor and the output member is disposed between the first motor and the second motor. Furthermore, in the hybrid drive system described in JP 2008-120234 A, a transmission gear device that changes the rotational speed of the engine and transmits torque to the power split mechanism is disposed between the first motor and the second motor.

In Japanese Patent Application Publication No. 2008-265598 (JP 2008-265598 A), a hybrid vehicle including an engine, a first motor, a second motor, and a power split mechanism constituted by a planetary gear unit having three rotation elements is described. The hybrid vehicle described in JP 2008-265598 A further includes a clutch that fixes an output shaft of the engine so as to make the output shaft unable to rotate. The first motor is connected to the output shaft of the engine via the power split mechanism, and the second motor is connected to drive wheels. Operations of the engine, first motor, second motor, and the clutch are respectively controlled according to the required driving force of the vehicle. When the clutch is engaged, and the output shaft of the engine is fixed, the hybrid vehicle is able to travel in a motor traveling mode in which both the first motor and the second motor are driven, in a condition where the power split mechanism functions as a speed reducing mechanism or a speed increasing mechanism.

Also, a hybrid vehicle similar in construction to the hybrid vehicle described in JP 2008-265598 A as described above is described in Japanese Patent Application Publication No. 2008-265600 (JP 2008-265600 A). In the hybrid vehicle described in JP 2008-265600 A, when a condition or conditions under which the clutch is engaged to fix the crankshaft of the engine so as to make it unable to rotate is/are satisfied, the operation of the engine is stopped, and rotations of two motors are respectively controlled, using a map that specifies torque split with which the two motors are most efficiently driven, based on the accelerator operation amount, vehicle speed, and the speed ratio of the transmission gear device.

### SUMMARY OF THE INVENTION

By adding a transmission gear mechanism (e.g., a transmission gear device) for changing the rotational speed of the engine to the arrangement of a known power transmitting apparatus for a hybrid vehicle including the engine, electric motor, and the power split mechanism, as in the hybrid drive system described in JP 2008-120234 A, it is possible to operate the engine at a rotational speed that is more advantageous to the fuel efficiency, according to the required driving force and traveling conditions. Consequently, the energy efficiency of the hybrid vehicle can be improved.

The transmission gear mechanism as described above includes a gear train, and friction devices (friction engagement devices), such as a clutch and a brake, for shift control. The friction devices, such as a clutch and a brake, are generally arranged to be controlled by use of hydraulic pressure. Namely, each of the friction devices included in the transmission gear mechanism as described above includes a plurality of friction members, and a hydraulic actuator for operating the friction members, and the friction members are arranged to engage with each other when a given hydraulic pressure is supplied to the hydraulic actuator. In the known arrangement, the hydraulic pressure is generally supplied to the hydraulic actuator, via an oil passage formed in the interior of a rotary shaft of the power transmitting apparatus.

When the hydraulic pressure is supplied to the hydraulic actuator via the oil passage formed within the rotary shaft as described above, a seal ring for preventing hydraulic leak is used at a connecting portion between the oil passage formed in the rotary shaft and an oil passage that communicate with the hydraulic actuator. The seal ring is provided between the outer periphery of the rotary shaft, and the inner periphery of a member that rotates relative to the rotary shaft. Accordingly, if the number of locations where the seal ring is used is increased, a dragging loss increases at sliding portions of the seal rings, and the energy efficiency of the system may be reduced.

The present invention provides a power transmitting apparatus for a hybrid vehicle which exhibits a high energy efficiency, even if the system is provided by adding a transmission gear mechanism for changing the rotational speed of an engine to the known system.

One aspect of the invention relates to a power transmitting apparatus for a hybrid vehicle including an engine as drive source, and a hydraulic actuator. The power transmitting apparatus includes at least one rotary machine, a power split mechanism, a housing, a transmission gear mechanism, a front cover, and a rotary machine cover. The above-indicated at least one rotary machine is a drive source of the hybrid vehicle. The power split mechanism is a differential mechanism having a first rotation element, a second rotation element to which the rotary machine is coupled, and a third rotation element to which a drive shaft is coupled. The power split mechanism is configured to split or combine dynamic power among the sources of driving force and the drive shaft and transmit the split or combined dynamic power to the sources of driving force or the drive shaft. The power split mechanism and the at least one rotary machine are disposed in the housing. The transmission gear mechanism has a friction device that is engaged or disengaged by the hydraulic actuator. The transmission gear mechanism is configured to change a rotational speed of the engine through engagement and disengagement of the friction device, and transmit torque of the engine to the first rotation element. The front cover covers one side of the transmission gear mechanism closer to the engine. The rotary machine cover covers the other side of the transmission gear mechanism closer to the power split mechanism. The transmission gear mechanism is disposed inside the front cover. The transmission gear mechanism is covered with the front cover and the rotary machine cover. The transmission gear mechanism, the front cover, and the rotary machine cover is a transmission gear unit. The transmission gear unit is provided to an end portion of the housing closer to the transmission gear mechanism. The oil passage for shift control is provided in the front cover or the rotary machine cover. The hydraulic pressure is supplied to the hydraulic actuator through the oil passage for the shift control.

In the power transmitting apparatus as described above, the friction device may include a clutch and a brake. The transmission gear mechanism may include a single planetary gear unit. The clutch may be configured to selectively connect a sun gear of the single planetary gear unit to a carrier of the single planetary gear unit. The brake may be configured to selectively fix the sun gear so as to make the sun gear unable to rotate. The oil passage for the shift control may include at least one of a communication hole and a tubular member. The communication hole may be provided in an interior of the front cover. The tubular member may be shaped along a shape of the front cover.

In the power transmitting apparatus as described above, the friction device may include a clutch and a brake. The transmission gear mechanism may include a double planetary gear unit. The clutch may be configured to selectively connect a sun gear of the double planetary gear unit to a carrier of the double planetary gear unit. The brake may be configured to selectively fix the sun gear so as to make the sun gear unable to rotate. The oil passage for the shift control may include at least one of a communication hole and a tubular member. The communication hole may be provided in an interior of the rotary machine cover. The tubular member may be shaped along a shape of the rotary machine cover.

In the power transmitting apparatus as described above, the transmission gear unit may be provided to the housing such that the oil passage for the shift control is connected to a supply oil passage. The supply oil passage may be provided in the housing. A hydraulic pressure may be supplied from a hydraulic source to the supply oil passage.

In the power transmitting apparatus according to the above aspect of the invention, the transmission gear mechanism for changing the rotational speed of the engine by hydraulically controlling the friction device with the hydraulic actuator is provided between the engine and the power split mechanism. The transmission gear mechanism is housed in the front cover and the rotary machine cover, to provide an integral transmission gear unit, against the housing as a principal part of the power transmitting apparatus in which the power split mechanism, rotary machine, etc. are disposed. Accordingly, the speed changing mechanism including the friction device and the hydraulic actuator can be handled as a sub-assembly.

In the power transmitting apparatus according to the above aspect of the invention, the oil passage for shift control, through which hydraulic pressure is supplied to the hydraulic actuator for hydraulic control of the speed changing mechanism, is provided in the front cover or rotary machine cover in which the speed changing mechanism is housed. For example, the oil passage for shift control is provided by a communication hole formed by drilling or boring in the interior of the front cover or rotary machine cover.

In another example, the oil passage for shift control is provided by a tubular member, such as a metal pipe, formed by bending along the shape of the front cover or rotary machine cover. The oil passages as described above are arranged to communicate with a supply oil passage formed in the housing, no matter how each oil passage is formed, in a condition where the transmission gear unit including the transmission gear mechanism is mounted to the housing. The supply oil passage of the housing is an oil passage through which hydraulic pressure for hydraulically controlling the friction device is supplied from the hydraulic source. Therefore, the hydraulic pressure for shift control is supplied to the hydraulic actuator of the friction device, via the supply oil passage of the housing, and the oil passage for shift control formed in the front cover or the rotary machine cover.

Accordingly, in the power transmitting apparatus according to the above aspect of the invention, the oil passage for shift control, through which the hydraulic pressure is supplied to the hydraulic actuator of the speed changing mechanism for hydraulic control of the speed changing mechanism, is formed in the front cover or rotary machine cover in which the transmission gear mechanism is housed. Namely, the oil passage for shift control is not formed in the interior of rotary shafts of the power transmitting apparatus, but formed in the front cover or the rotary machine cover. In the related art, the power transmitting apparatus for vehicle of this type is generally configured such that oil passages formed in the interior of the rotary shafts are used for supplying hydraulic oil for control of friction devices (friction mechanism), etc., and lubricating oil for lubrication or cooling of respective parts of the system. On the other hand, in the power transmitting apparatus according to the invention, the oil passage for shift control, through which the hydraulic pressure for shift control is supplied, is not formed within the rotary shaft of the power transmitting apparatus, but formed in the front cover or the rotary machine cover. Therefore, the oil passages formed within the rotary shafts as in the related art can be exclusively used for lubricating oil having a lower pressure than the control hydraulic pressure. As a result, the arrangement of oil passages formed within the rotary shafts can be simplified. While seal rings for preventing or curbing hydraulic leak need to be used when the oil passages are formed within the rotary shafts, the number of the seal rings used for the rotary shafts can be reduced, since the oil passage for shift control is formed in the front cover or the rotary machine cover. Therefore, the dragging loss that would appear at sliding portions of the seal rings during rotation of the rotary shaft can be reduced. Consequently, the energy efficiency of the power transmitting apparatus can be improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a skeleton diagram useful for explaining a drive train of a hybrid vehicle to which this invention is applied, showing an example of drive train suitable for installation on an FR-type vehicle, wherein a transmission gear mechanism is constituted by a single pinion type planetary gear unit;

FIG. 2 is a skeleton diagram useful for explaining a driven train of a hybrid vehicle to which this invention is applied, showing an example of drive train suitable for installation on an FF-type vehicle, wherein a transmission gear mechanism is constituted by a single pinion type planetary gear unit;

FIG. 3 is a table indicating operating states of a clutch, a brake, and first and second motor-generators, in each driving state of the drive train shown in FIG. 1 or FIG. 2;

FIG. 4 is a nomographic chart in connection with a power split mechanism and a transmission gear mechanism in the drive train shown in FIG. 1 or FIG. 2, showing a condition where the vehicle travels only with the output of the second motor-generator;

FIG. 5 is a nomographic chart in connection with the power split mechanism and the transmission gear mechanism in the drive train shown in FIG 1 or FIG. 2, showing a condition where the vehicle travels with the outputs of both of the first motor-generator and the second motor-generator;

FIG. 6 is a nomographic chart in connection with the power split mechanism and the transmission gear mechanism in the drive train shown in FIG 1 or FIG. 2, showing a condition where the speed changing mechanism is set in an O/D speed position (High);

FIG. 7 is a nomographic chart in connection with the power split mechanism and the transmission gear mechanism in the drive train shown in FIG. 1 or FIG. 2, showing a condition where the transmission gear mechanism is set in a direct-coupling speed position (Low);

FIG. 8 is a block diagram useful for explaining a control system of the hybrid vehicle to which this invention is applied;

FIG. 9 is a map (graph) used in control of the operation of the hybrid vehicle to which this invention is applied, and shift control of the transmission gear mechanism, showing an engine traveling range and a motor traveling range;

FIG. 10 is a skeleton diagram useful for explaining a drive train of a hybrid vehicle to which this invention is applied, showing an example of drive train suitable for installation on an FR-type vehicle, wherein a transmission gear mechanism is constituted by a double pinion type planetary gear unit;

FIG. 11 is a skeleton diagram useful for explaining a drive train of a hybrid vehicle to which this invention is applied, showing an example of drive train suitable for installation on an FF-type vehicle, wherein a transmission gear mechanism is constituted by a double pinion type planetary gear unit;

FIG. 12 is a cross-sectional view useful for specifically explaining the construction of a power transmitting apparatus for a hybrid vehicle according to this invention, showing an example in which a transmission gear mechanism is constituted by a single pinion type planetary gear unit; and

FIG. 13 is a cross-sectional view useful for specifically explaining the construction of a power transmitting apparatus for a hybrid vehicle according to this invention, showing an example in which a transmission gear mechanism is constituted by a double pinion type planetary gear unit.

### DETAILED DESCRIPTION OF EMBODIMENTS

Next, this invention will be specifically described with reference to the drawings. The power transmitting apparatus according to the invention is installed on a vehicle including an engine that generates dynamic power by converting thermal energy to kinetic energy, and a rotary machine capable of energy regeneration, as sources of driving force, namely, a hybrid vehicle including two or more sources of driving force having different dynamic power generation principles.

A gasoline engine is most commonly used as the engine included in the hybrid vehicle. Other than the gasoline engine, an internal combustion engine, such as a diesel engine or an LPG engine, which uses a fuel other than gasoline, may be used as the engine included in the invention. On the other hand, a motor having a power generating capability (i.e., a motor-generator) is most commonly used as the rotary machine. Other than the motor-generator, a pressure motor having the function of accumulating pressure, such as hydraulic pressure or pneumatic pressure, a flywheel capable of storing and releasing rotational energy, or the like, may be used as the rotary machine included in the invention.

The hybrid vehicle to which this invention is applied is configured to operate in a traveling mode selected from “engine traveling mode” in which the vehicle travels with dynamic power generated by the engine, “HV (hybrid) traveling mode”, and a traveling mode in which the vehicle travels with dynamic power generated by the rotary machine. In the case where a motor is used as the rotary machine, in particular, the traveling mode of the hybrid vehicle may be selected from “engine traveling mode”, and “motor traveling mode” in which the vehicle travels with the motor driven by electric power stored in a battery.

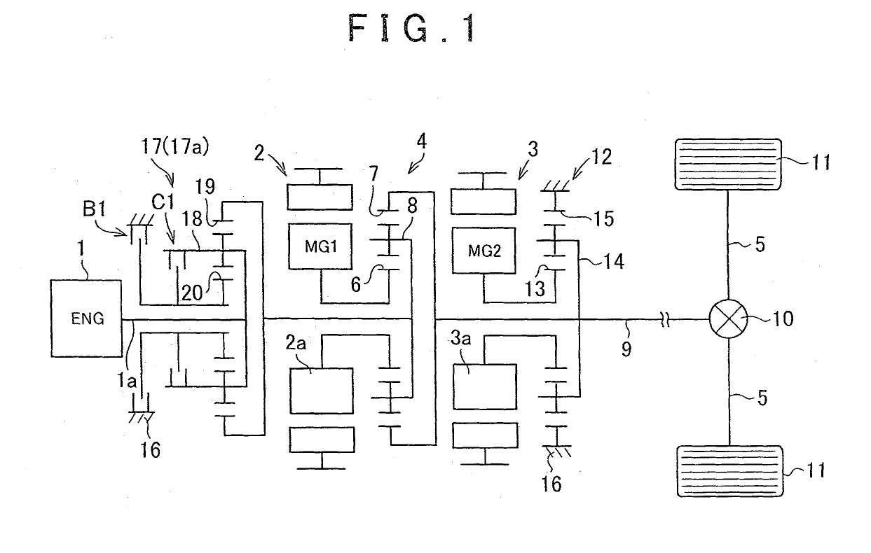

FIG. 1 shows one example of power train of the hybrid vehicle to which this invention is applied. The example shown in FIG. 1 is a so-called two-motor-type hybrid vehicle Ve using an engine (ENG) 1, and two rotary machines in the form of a first motor-generator (MG1) 2 and a second motor-generator (MG2) 3, as sources of driving force. The hybrid vehicle Ve has a power split mechanism 4 that divides or splits dynamic power generated by the engine 1, and transmits the dynamic power to one side closer to the first motor-generator 2 and the other side close to drive shafts 5. The hybrid vehicle Ve is also operable such that electric power generated by the first motor-generator 2 is supplied to the second motor-generator (MG2) 3, and dynamic power generated by the second motor-generator 3 by use of the electric power can be added to power received by the drive shafts 5.

The power split mechanism 4 is constituted by a differential mechanism having three rotation elements. More specifically, the power split mechanism 4 is constituted by a planetary gear unit having a sun gear 6 as a first rotation element, a carrier 8 as a second rotation element, and a ring gear 7 as a third rotation element. In the example shown in FIG. 1, a single-pinion-type planetary gear unit is used.

The planetary gear unit that constitutes the power split mechanism 4 is disposed on the same axis as the engine 1. The first motor-generator 2 is coupled to the sun gear 6 of the planetary gear unit. Namely, a rotor 2a of the first motor-generator 2 is coupled with the sun gear 6. The ring gear 7 is disposed concentrically with respect to the sun gear 6. A pinion gear that meshes with the sun gear 6 and the ring gear 7 is held by the carrier 8 such that the pinion gear can rotate about its own axis and rotate about the axis of the power split mechanism 4. An output shaft la of the engine 1 is coupled to the carrier 8, via a transmission gear mechanism 17 (which will be described later). A propeller shaft 9 has one end portion that is coupled to the ring gear 7. The other end portion of the propeller shaft 9 is connected to the drive shafts 5 and drive wheels 11, via a differential gear 10.

The power train of the hybrid vehicle as shown in FIG. 1 is configured to add torque produced by the second motor-generator 3, to torque transmitted from the power split mechanism 4 to the propeller shaft 9 and the drive wheels 11. More specifically, the second motor-generator 3 is disposed on the same rotational axis as the engine 1, and the second motor-generator 3 is connected to the propeller shaft 9 via a gear train 12.

In the example shown in FIG. 1, a single pinion type planetary gear unit is used as the gear train 12. A sun gear 13 of the planetary gear unit that constitutes the gear train 12 is coupled to a rotor 3a of the second motor-generator 3. A carrier 14 of the gear train 12 is coupled to the propeller shaft 9. A ring gear 15 of the gear train 12 is fixed to a stationary member 16, such as a casing, such that the ring gear 15 cannot rotate. Namely, in the gear train 12, the ring gear 15 is a fixed element. The carrier 14 that serves as an output element when the sun gear 13 is an input element is adapted to rotate at a lower speed than the sun gear 13, in the same direction as the sun gear 13. Accordingly, the gear train 12 functions as a speed reducing mechanism when it generates torque applied to the sun gear 13, from the carrier 14. Namely, the gear train 12 is arranged to amplify torque applied from the second motor-generator 3 to the sun gear 13, and transmit the resulting torque to the propeller shaft 9.

The first motor-generator 2 and the second motor-generator 3 are respectively connected to a battery, via controllers, such as inverters (not shown). In operation, electric current passed through each of the first motor-generator 2 and the second motor-generator 3 is controlled so that each motor-generator 2, 3 functions as a motor or a generator. On the other hand, the engine 1 is controlled through control of its throttle opening and ignition timing. Also, automatic stop of combustion operation of the engine 1, and start and re-start of the engine 1, are controlled.

In the hybrid vehicle Ve to which the invention is applied, the transmission gear mechanism 17 is provided between the engine 1, and the power split mechanism 4 and first motor-generator 2. The transmission gear mechanism 17 is arranged to be switched to one of a direct-coupling speed position, and a speed-increase speed position or overdrive (O/D) speed position. In the example shown in FIG. 1, the transmission gear mechanism 17 is constituted by a single pinion type planetary gear unit 17a having a carrier 18, a ring gear 19, and a sun gear 20. The carrier 18 is coupled to the output shaft la of the engine 1. The ring gear 19 is coupled to the carrier 8 of the power split mechanism 4 as described above so as to rotate as a unit with the carrier 8. A clutch C1 for selectively coupling the sun gear 20 with the carrier 18 is provided between the sun gear 20 and the carrier 18. A brake B1 is provided for selectively fixing the sun gear 20 in a non-rotatable state. The clutch C1 and the brake B1 may be constituted by friction devices that are hydraulically engaged and released, for example.

In the transmission gear mechanism 17, when the clutch C1 is engaged, the sun gear 20 and the carrier 18 of the planetary gear unit 17a are coupled to each other. As a result, the whole planetary gear unit 17a rotates as a unit, and is thus placed in a so-called directly connected state in which no speed increasing effect nor speed reducing effect is produced. When the brake B1 as well as the clutch C1 is engaged, the whole planetary gear unit 17a is fixed as a unit, and rotation of the carrier 8 of the power split mechanism 4 and rotation of the engine 1 are stopped. On the other hand, when only the brake B1 is engaged, the sun gear 20 of the transmission gear mechanism 17 becomes a fixed element, and the carrier 18 becomes an input element. Therefore, the ring gear 19 that becomes an output element when the carrier 18 is the input element rotates at a higher speed than the carrier 18, in the same direction as the carrier 18. Accordingly, the transmission gear mechanism 17 functions as a speed increasing mechanism. Namely, the transmission gear mechanism 17 is placed in the O/D speed position.

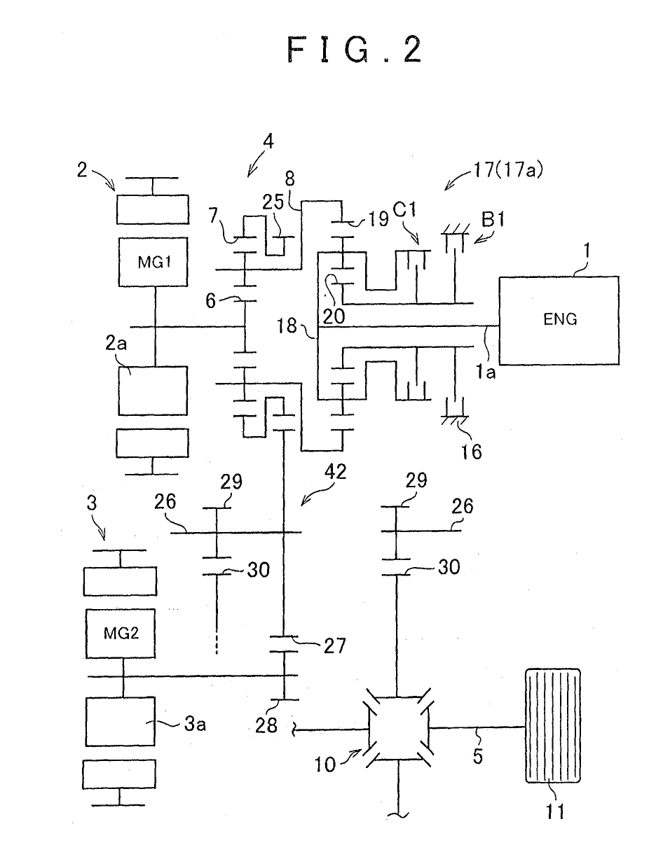

In the example of the hybrid vehicle Ve shown in FIG. 1, drive torque generated from one or more sources of driving force is transmitted to the drive shafts 5 and the drive wheels 11 via the propeller shaft 9. Namely, the drive train of the hybrid vehicle Ve is suitable for installation on a so-called FR-type vehicle in which the sources of driving force are located in a front part of the vehicle, and the driving force is generated at the rear wheels. Meanwhile, this invention may also be applied to a so-called FF-type vehicle in which the sources of driving force are located in a front part of the vehicle, and the driving force is generated at the front wheels. An example of the drive train suitable for installation on the FF-type vehicle is illustrated in FIG. 2.

As in the above-described example shown in FIG. 1, the hybrid vehicle Ve shown in FIG. 2 includes the engine 1, and the first motor-generator 2 and second motor-generator 3, as sources of driving force. The hybrid vehicle Ve also includes the transmission gear mechanism 17, power split mechanism 4, and the gear train 12. The transmission gear mechanism 17 is constituted by the single pinion type planetary gear unit 17a, clutch C1, and the brake B1, as in the example shown in FIG. 1. The output shaft 1a of the engine 1 is coupled to the carrier 18 of the planetary gear unit 17a. The carrier 8 of the power split mechanism 4 is coupled to the ring gear 19. In the example shown in FIG. 2, a drive gear 25 is coupled to the ring gear 7 of the power split mechanism 4. Also, the gear train 12 consists of the above-mentioned drive gear 25, counter shaft 26, counter driven gear 27, reduction gear 28, and a differential drive gear 29.

More specifically, the counter shaft 26 is disposed in parallel with the rotational axis of the engine 1, power split mechanism 4, etc. The counter driven gear 27 that engages with the drive gear 25 is mounted so as to rotate as a unit with the counter shaft 26. Furthermore, the power train of FIG. 2 is configured such that torque produced by the second motor-generator 3 can be added to torque transmitted from the power split mechanism 4 to the drive shafts 5. Namely, the second motor-generator 3 is disposed in parallel with the counter shaft 26, and the reduction gear 28 coupled to the rotor 3a is in meshing engagement with the counter driven gear 27. The reduction gear 28 has a smaller diameter than the counter driven gear 27. Accordingly, the gear train 12 functions as a speed reducing mechanism when it transmits torque applied to the reduction gear 28 to the counter shaft 26 via the counter driven gear 27. Namely, the gear train 12 is arranged to amplify the torque produced by the second motor-generator 3 and transmit the resulting torque to the counter shaft 26.

The differential drive gear 29 is mounted on the counter shaft 26 so as to rotate together with the counter shaft 26. Also, in the example shown in FIG. 2, a ring gear 30 is formed in an outer peripheral portion of the differential gear 10. The differential drive gear 29 is in meshing engagement with the ring gear 30 formed in the differential gear 10. Accordingly, torque applied to the power split mechanism 4 and generated from the ring gear 7, and torque generated from the second motor-generator 3, are transmitted to the drive shafts 5 and the drive wheels 11, via the gear train 12 and the differential gear 10. In FIG. 2, the position of the differential gear 10 is shifted to the right in FIG. 2, for the sake of convenience in drawing of FIG. 2.

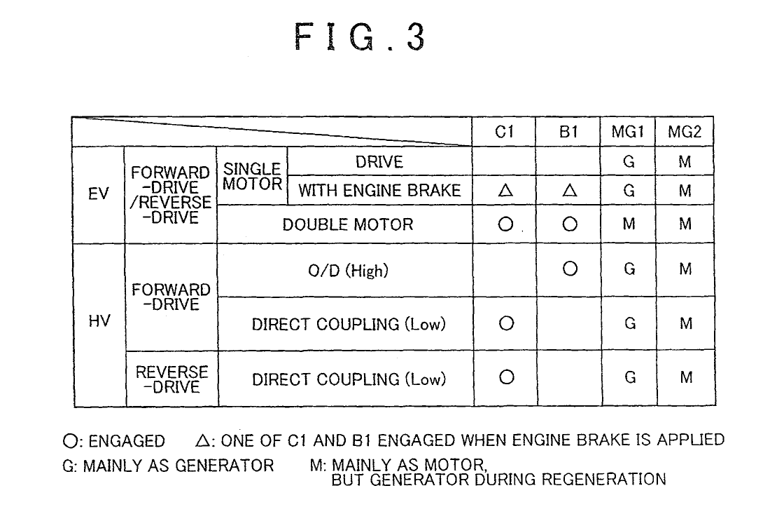

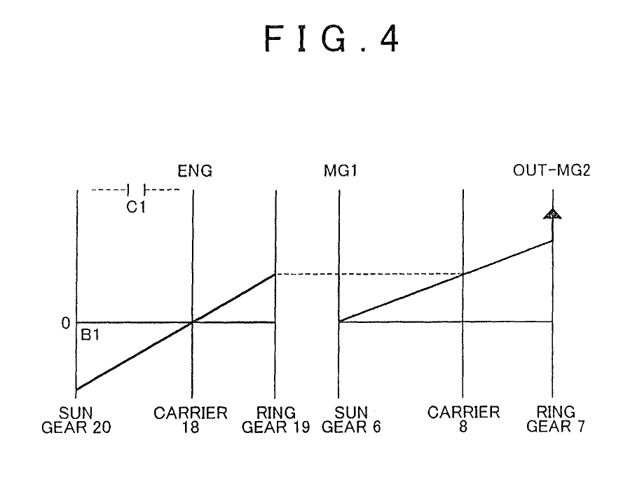

The table of FIG. 3 shows engaged/released states of the clutch C1 and the brake B1, and the operating states of the first motor-generator 2 and the second motor-generator 3, when the hybrid vehicle Ve as shown in FIG. 1 or FIG. 2 is traveling forward and backward in each of the above-indicated traveling modes. Each operating state of the hybrid vehicle Ve will be briefly explained. In FIG. 3, “EV” denotes “motor traveling mode”. In “single motor traveling mode”, both of the clutch C1 and the brake B1 are released. Then, the second motor-generator 3 is operated as a motor (M), and the first motor-generator 2 functions as a generator (G). In this case, the first motor-generator 2 may run idle. This operating state is illustrated in the nomographic chart of FIG. 4. To produce an engine brake effect in the “single motor traveling mode”, one of the clutch C1 and the brake B1 is engaged, so that the rotational speed of the ring gear 7 in the power split mechanism 4 is reduced.

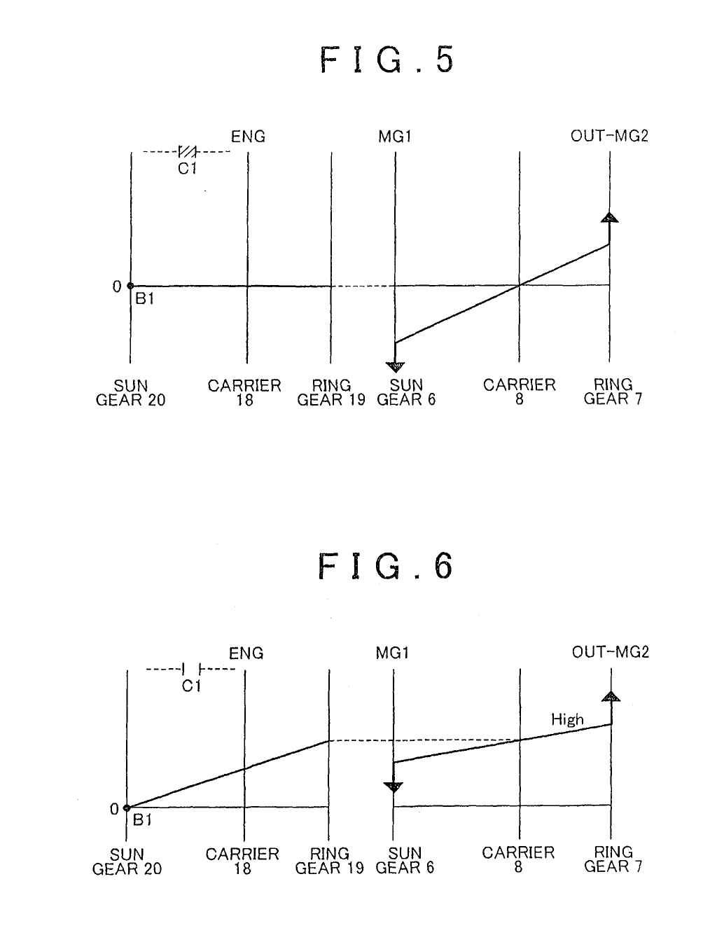

In “double motor traveling mode” as another type of the motor traveling mode as described above, both of the first motor-generator 2 and the second motor-generator 3 function as motors. In this mode, the clutch C1 and the brake B1 are both engaged, and the carrier 8 of the power split mechanism 4 is fixed in a non-rotatable state, so that torque produced by the first motor-generator 2 is transmitted to the drive shafts 5. The gear ratios between rotation elements of the power split mechanism 4 are set so that the power split mechanism 4 functions as a speed reducer in this condition. Accordingly, in this case, the torque produced by the first motor-generator 2 is amplified, and transmitted from the ring gear 7 of the power split mechanism 4 to the propeller shaft 9. This operating state is illustrated in the nomographic chart of FIG. 5.

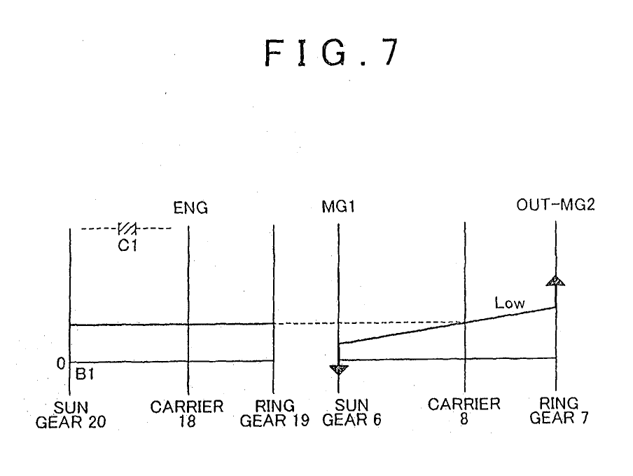

In the table of FIG. 3, “HV” denotes “hybrid traveling mode” in which the engine 1 is driven. Where the vehicle Ve is traveling at a light load and a middle to high speed, the transmission gear mechanism 17 is set in the O/D state (High). Namely, the clutch C1 is released, and the brake B1 is engaged. This operating state is illustrated in the nomographic chart of FIG. 6. In this state, the engine speed is controlled by the first motor-generator 2 to a rotational speed that provides high fuel efficiency, as described above. In this case, electric power generated by the first motor-generator 2 that functions as a generator is supplied to the second motor-generator 3. As a result, the second motor-generator 3 operates as a motor, and generates driving torque. When large driving force is required, such as when the vehicle travels at a low speed and the accelerator operation amount is increased, the transmission gear mechanism 17 is controlled to the directly connected state (Low). Namely, the clutch C1 is engaged, and the brake B1 is released. As a result, the whole transmission gear mechanism 17 rotates as a unit. This operating state is illustrated in the nomographic chart of FIG. 7. In this case, too, the first motor-generator 2 is operated as a generator, and the second motor-generator 3 is operated as a motor, as in the case of the O/D state (High).

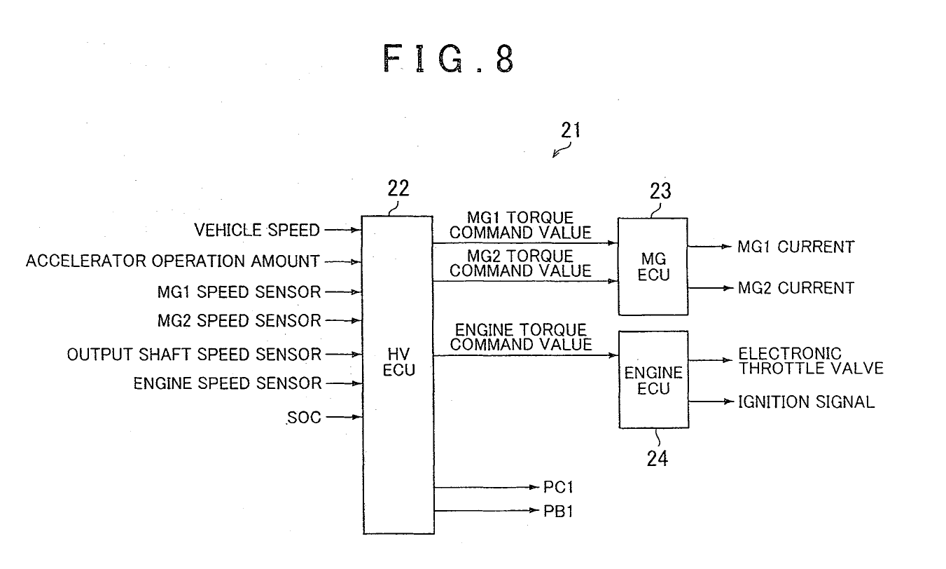

An electronic control unit (ECU) 21 is provided for controlling operation of the engine 1, operation of the first motor-generator 2 and the second motor-generator 3, and controlling engagement and release of the clutch C1 and the brake B1. A control system of the ECU 21 is illustrated in the block diagram of FIG. 8.

The ECU 21 includes a hybrid control unit (HV-ECU) 22 for performing overall control for traveling the hybrid vehicle, a motor-generator control unit (MG-ECU) 23 for controlling the first motor-generator 2 and the second motor-generator 3, and an engine control unit (E/G-ECU) 24 for controlling the engine 1, for example. Each of these control units 22, 23, 24 is mainly comprised of a microcomputer, and is configured to perform computations using input data and pre-stored data, and output the results of computations as control command signals.

Examples of input data received by the ECU 21 will be listed below. For example, the HV-ECU 22 receives the vehicle speed, the accelerator operation amount, the rotational speed of the first motor-generator 2, the rotational speed of the second motor-generator 3, the rotational speed of the ring gear 7 (output shaft speed), the rotational speed of the engine 1, the SOC of the battery, and so forth. Examples of output data generated from the ECU 21 will be listed below. For example, the HV-ECU 22 outputs a torque command value for the first motor-generator 2, a torque command value for the second motor-generator 3, a torque command value for the engine 1, a hydraulic command value PC1 for the clutch C1, a hydraulic command value PB1 for the brake B1, and so forth.

The MG-ECU 23 receives the torque command value for the first motor-generator 2 and the torque command value for the second motor-generator 3, as control data. Then, the MG-ECU 23 is configured to output current command signals to the first motor-generator 2 and the second motor-generator 3. Also, the E/G-ECU 24 receives the engine torque command signal as control data. Then, the E/G-ECU 24 is configured to perform computations based on the engine torque command signal, and output a throttle opening signal to an electronic throttle valve (not shown), an ignition signal for controlling the ignition timing, and so forth.

The engine 1, the first motor-generator 2, and the second motor-generator 3, which provide the sources of driving force of the hybrid vehicle Ve as described above, have different dynamic power performances and driving characteristics. For example, the engine 1 is able to operate in a wide operating range from a low-torque, low-speed range to a high-torque, high-speed range. Also, the energy efficiency of the engine 1 is good in an operating range in which the torque and the rotational speed are relatively high. On the other hand, the first motor-generator 2 is characterized by producing large torque at a low rotational speed, so as to perform control for adjusting the rotational speed of the engine 1, the crank angle at the time of stopping the engine 1, etc., and generate driving force The second motor-generator 3 can operate at a higher rotational speed that the first motor-generator 2, so as to generate torque to the drive shafts 5, and has a characteristic that the maximum torque is smaller than that of the first motor-generator 2.

The hybrid vehicle Ve, which includes the engine 1, the first motor-generator 2 and the second motor-generator 3, as sources of driving force, is controlled so as to provide high energy efficiency and high fuel efficiency, by effectively utilizing these sources of driving force. Namely, one of the “engine traveling mode” in which the vehicle travels with output of the engine 1, and the “motor traveling mode” in which the vehicle travels with output of at least one of the first motor-generator 2 and the second motor-generator 3, is selected and established according to the traveling conditions of the hybrid vehicle Ve.

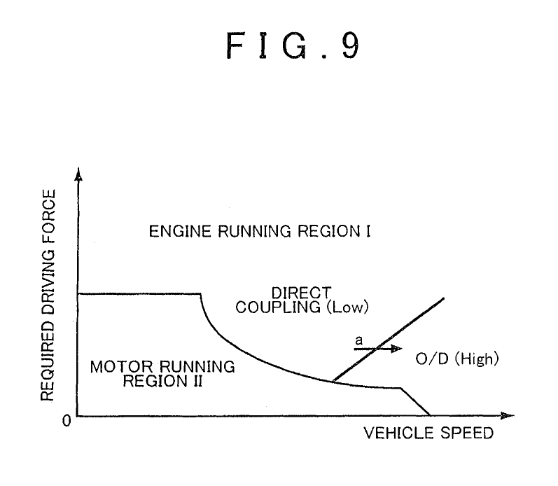

The map of FIG. 9 shows operating ranges in which the respective traveling modes as described above are set. In FIG. 9 indicating the operating ranges of the vehicle Ve, the horizontal axis indicates the vehicle speed, and the vertical axis indicates the required driving force. A range denoted by symbol 1 is an engine traveling range in which the “engine traveling mode” is executed, and a range denoted by symbol II is a motor traveling range in which the “motor traveling mode” is executed. In the engine traveling range I, a line of threshold values T is set which partitions this range I into a range in which the transmission gear mechanism 17 is controlled to the directly connected state (Low), and a range in which the transmission gear mechanism 17 is controlled to the O/D state (High). Thus, the traveling mode and the speed position of the transmission gear mechanism 17 are selected and set according to the required driving force required of the hybrid vehicle Ve. For example, if an operating point determined by the vehicle speed and the required driving force moves from the range of the directly connected state (Low) to the range of the O/D state (High), as indicated by arrow “a” in FIG. 9, the transmission gear mechanism 17 is shifted from the directly connected state (Low) to the O/D state (High). The ECU 21 as described above is configured to carry out control for switching the traveling mode and switching the speed position in the transmission gear mechanism 17, according to change of the operating range or operating point as described above.

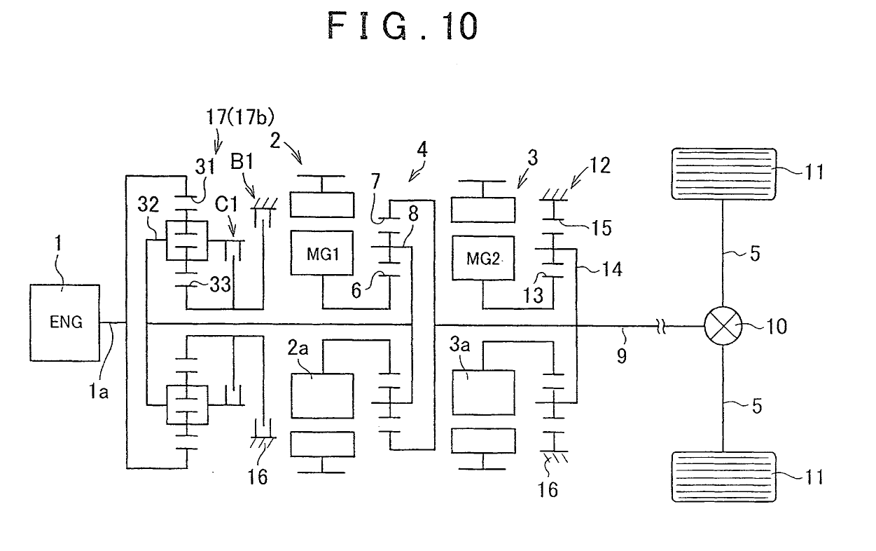

In the examples of hybrid vehicles Ve shown in FIG. 1 and FIG. 2 as described above, the transmission gear mechanism 17 is constructed using the single planetary gear unit 17a. According to this invention, the transmission gear mechanism 17 may also be constructed using a double planetary gear unit. FIG. 10 shows an example in which the transmission gear mechanism 17 uses such a double planetary gear unit, and the drive train is suitable for installation on an FR-type vehicle.

The hybrid vehicle Ve shown in FIG. 10 is different from the above-described hybrid vehicle Ve shown in FIG. 1 only in the arrangement of the transmission gear mechanism 17, and the coupling relationship between the transmission gear mechanism 17, and the engine 1 and the first motor-generator 2. More specifically, in the example as shown in FIG. 10, the transmission gear mechanism 17 is constituted by a double pinion type planetary gear unit 17b having a ring gear 31, a carrier 32, and a sun gear 33. The ring gear 31 is coupled to the output shaft 1a of the engine 1. The carrier 32 is coupled to the carrier 8 of the power split mechanism 4 so as to rotate as a unit with the carrier 8. The carrier 32 in the example shown in FIG. 10 holds two pinion gears such that the gears can rotate about themselves and rotate about the axis of the transmission gear mechanism 17. One of the two pinion gears meshes with the sun gear 33, and the other pinion gear meshes with the ring gear 31, while the two pinion gears mesh with each other. The clutch C1 for selectively coupling the sun gear 33 with the carrier 32 is provided between the sun gear 33 and the carrier 32. Also, the brake B1 is provided for selectively fixing the sun gear 33 in a non-rotatable condition.

In the transmission gear mechanism 17 in the example shown in FIG. 10, too, when the clutch C1 is engaged, the sun gear 33 and carrier 32 of the planetary gear unit 17b are coupled to each other, as in the above-described example shown in FIG. 1. As a result, the whole planetary gear unit 17b rotates as a unit, and the transmission gear mechanism 17 is placed in a so-called directly connected state in which the mechanism 17 produces no speed-increasing effect nor speed-reducing effect. If the brake B1 is engaged in addition to the clutch C1, the whole transmission gear mechanism 17 is fixed as a unit, and rotation of the carrier 8 of the power split mechanism 4 and the engine 1 is stopped. On the other hand, if only the brake B1 is engaged, the sun gear 33 becomes a fixed element, and the ring gear 31 becomes an input element, in the transmission gear mechanism 17 in the example shown in FIG. 10. Therefore, the carrier 32 that becomes an output element when the ring gear 31 is the input element rotates at a higher speed than the ring gear 31, in the same direction as the ring gear 31. Accordingly, the transmission gear mechanism 17 functions as a speed increasing mechanism. Namely, the O/D speed position (High) is established in the transmission gear mechanism 17.

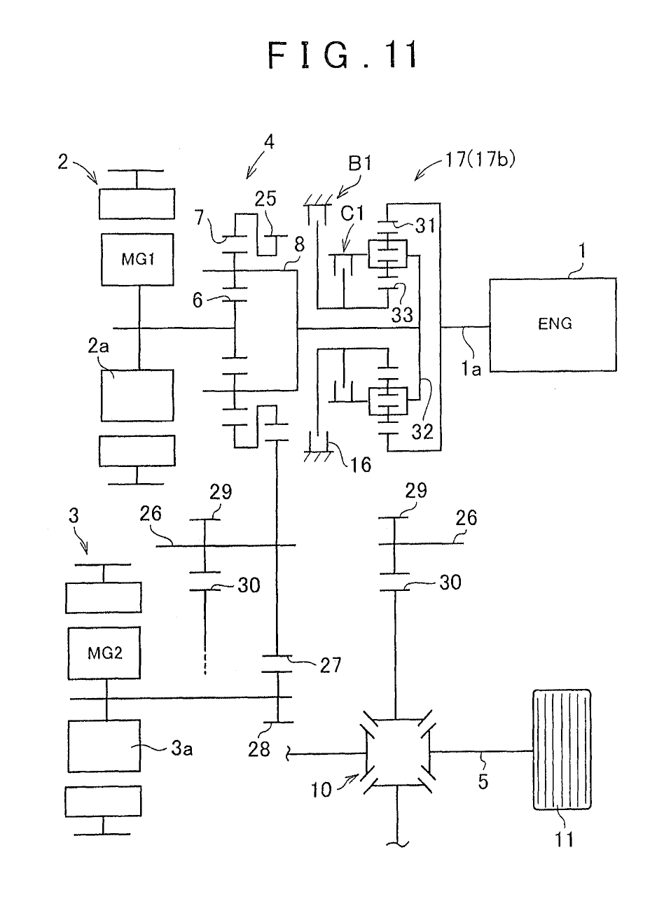

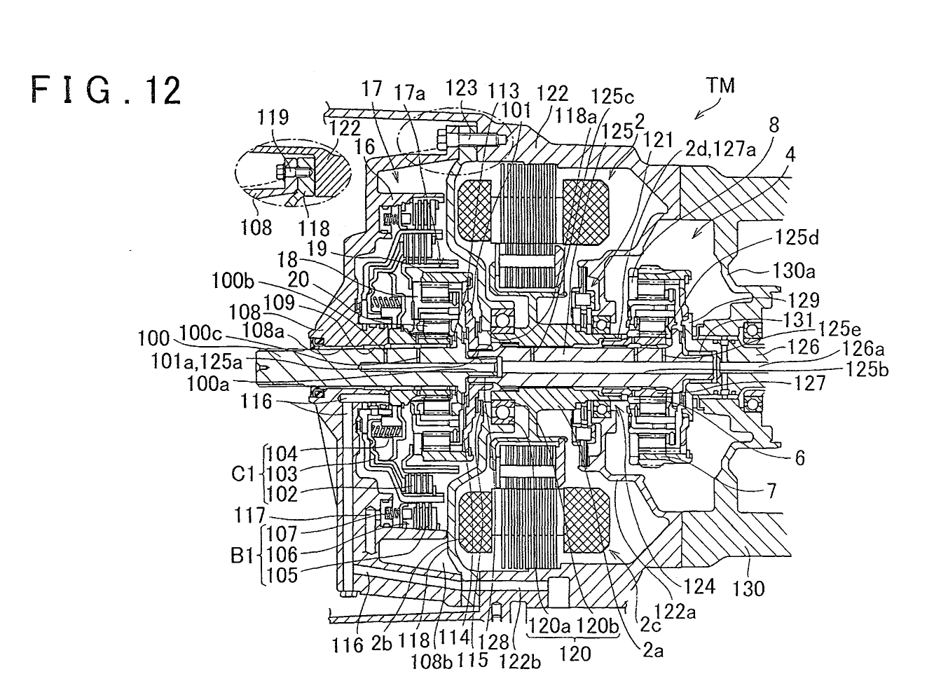

FIG. 11 shows an example in which the transmission gear mechanism 17 is constructed using a double planetary gear unit, and the drive train is suitable for installation on an FF-type vehicle. The hybrid vehicle Ve shown in FIG. 11 is different from the above-described hybrid vehicle Ve shown in FIG. 2 only in the arrangement of the transmission gear mechanism 17, and the coupling relationship between the transmission gear mechanism 17, and the engine 1 and the first motor-generator 2. The transmission gear mechanism 17 constituted by the double pinion type planetary gear unit 17b, and the coupling relationship between the transmission gear mechanism 17, and the engine 1 and the first motor-generator 2, are similar to those of the drive train of the hybrid vehicle Ve shown in FIG. 10.

As described above, the power transmitting apparatus TM for the hybrid vehicle according to this invention includes the transmission gear mechanism 17 provided between the engine 1 and the power split mechanism 4 for changing the rotational speed of the engine 1. The transmission gear mechanism 17 includes friction devices, i.e., the clutch C1 and the brake B1, for switching the speed position between the directly connected state (Low) and the O/D state (High). The clutch C1 and brake B1 of the transmission gear mechanism 17 are controlled by use of hydraulic pressure, as in the known arrangement. Namely, each of the clutch C1 and the brake B1 includes a hydraulic actuator for controlling the engaged and released states thereof, as will be described later.

Accordingly, in the power transmitting apparatus TM for the hybrid vehicle according to the invention, there is a need to separately provide oil passages for shift control, through which hydraulic pressures are supplied to the hydraulic actuators when the operation of the transmission gear mechanism 17 is controlled, as compared with the known power transmitting apparatus for the hybrid vehicle having no mechanism like the transmission gear mechanism 17. As the oil passages for shift control, oil passages formed in the interior of a rotary shaft or shafts for supplying lubricating oil to respective parts of devices in the known system may be utilized. However, a larger pressure is applied to the oil passages for shift control, as compared with the oil passages for lubrication; therefore, there is a need to separately provide members or mechanisms, such as seal rings, for dealing with hydraulic leak. If the number of locations where the seal rings are used is increased, for example, the arrangement of the oil passages formed within the rotary shaft(s) becomes complicated, and a dragging loss appearing in sliding portions of the seal rings is increased.

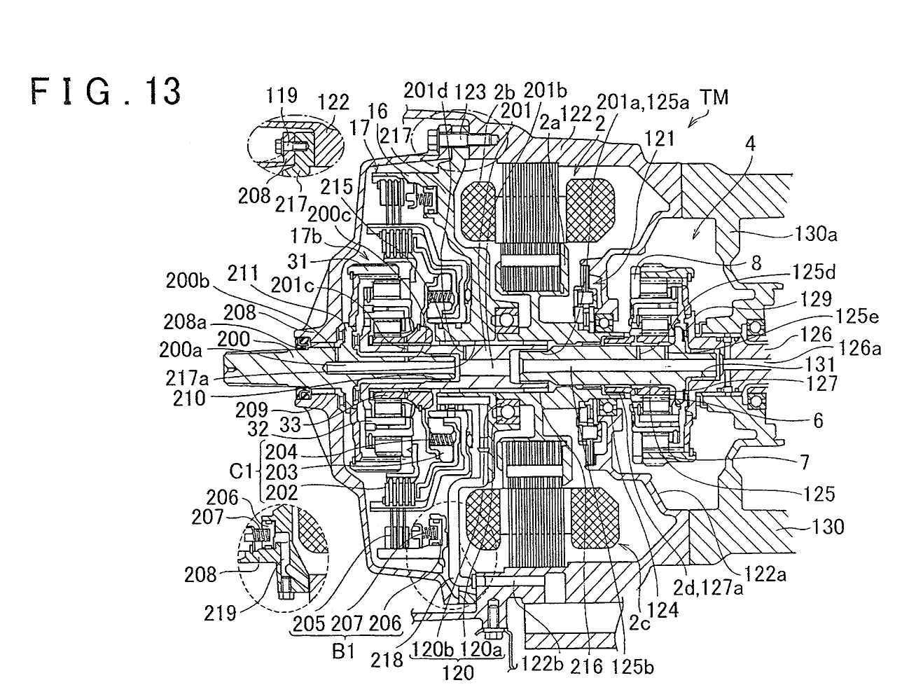

The power transmitting apparatus for the hybrid vehicle according to this invention is simplified in construction even when the transmission gear mechanism 17 as described above is added to the arrangement of the known system, and the dragging loss caused by the seal rings, etc., can be reduced. One specific example of the arrangement is illustrated in FIG. 12. A power transmitting apparatus TM shown in FIG. 12 corresponds to the arrangement of the drive train as shown in FIG. 1 and FIG. 2. Namely, in the example of FIG. 12, the transmission gear mechanism 17 is constituted by the single pinion type planetary gear unit 17a.

The power transmitting apparatus TM includes the transmission gear mechanism 17, first motor-generator 2, and the power split mechanism 4. The transmission gear mechanism 17, first motor-generator 2, and the power split mechanism 4 are arranged in the order of description, in a direction from the side closer to the engine 1 (not shown in FIG. 12), namely, from the front side (the left-hand side in FIG. 12) of the power transmitting apparatus TM.

The transmission gear mechanism 17 consists of the single pinion type planetary gear unit 17a, clutch C1 and brake B1, input shaft 100, and an output flange 101. The clutch C1 includes a friction material 102 for coupling the sun gear 20 and the carrier 18 of the planetary gear unit 17a to each other, and a hydraulic actuator 103 and a return spring 104 that operate the friction material 102 so as to bring the clutch C1 into the engaged or released state. In operation, hydraulic pressure for engaging the clutch C1 is supplied to the hydraulic actuator 103, via an oil passage 116 for shift control, which will be described later. Meanwhile, the brake B1 includes a friction material 105 for fixing the sun gear 20 of the planetary gear unit 17a in a non-rotatable condition, and a hydraulic actuator 106 and a return spring 107 that operate the friction material 105 so as to bring the brake B1 into the engaged or released state. In operation, hydraulic pressure for engaging the brake B1 is supplied to the hydraulic actuator 106, via an oil passage 117 for shift control, which will be described later.

A front cover 108 is provided for housing the above-described planetary gear unit 17a, clutch C1 and brake B1, and the input shaft 100. The front cover 108 covers a portion of the power transmitting apparatus TM which is opposed to the engine 1 in a condition where the assembling of the system TM is completed. In the power transmitting apparatus TM as shown in FIG. 12, the planetary gear unit 17a, clutch C1 and brake B1, input shaft 100, and the output flange 101 are incorporated inside the front cover 108.

More specifically, the hydraulic actuator 103 and the return spring 104, and the hydraulic actuator 106 and the return spring 107, are mounted in a front part of the inside of the front cover 108, namely, on the side (left-hand side in FIG. 12) closer to the engine 1 that is not shown in FIG. 12. The planetary gear unit 17a is disposed in the rear (on the right-hand side in FIG. 12) of the hydraulic actuator 103, 106 and the return spring 104, 107 at the radially inner side of the hydraulic actuator 103, 106 and the return spring 104, 107.

The input shaft 100 that functions as an input member of the transmission gear mechanism 17 is disposed radially inside of the sun gear 20 of the planetary gear unit 17a, such that the input shaft 100 is rotatable relative to the sun gear 20. The input shaft 100 is supported by a needle bearing 109 provided in an inner circumferential portion of a through-hole 108a formed in the front cover 108, and a bush 128 provided in an inner circumferential portion of a countersunk hole formed in an input shaft 125 of the power split mechanism 4 which will be described later.

The input shaft 100 is formed with a flange 113 that rotates as a unit with the input shaft 100, and the carrier 18 of the planetary gear unit 17a is coupled to the flange 113 so as to rotate as a unit with the flange 113. Namely, the input shaft 100 and the carrier 18 are coupled to each other so as to rotate as a unit. A front end portion (on the left-hand side in FIG. 12) of the input shaft 100 protrudes from the through-hole 108a, so that the input shaft 100 and the output shaft 1a of the engine 1 are coupled to each other via a damper mechanism (not shown), or the like. A rear end portion (on the right-hand side in FIG. 12) of the input shaft 100 is supported by the input shaft 125 of the power split mechanism 4 which will be described later.

The output flange 101 that functions as an output member of the transmission gear mechanism 17 is disposed radially outside of a rear end portion of the input shaft 100, in the rear of the above-mentioned flange 113, such that the output flange 101 can rotate relative to the input shaft 100. The output flange 101 is supported by a thrust bearing 114 provided between the output flange 101 and the flange 113, and a thrust bearing 115 provided between the output flange 101 and an MG1 cover 118 which will be described later.

The ring gear 19 of the planetary gear unit 17a is coupled to the output flange 101 so as to rotate as a unit with the output flange 101. Internal splines 101a are formed in a rear end portion of the output flange 101. The internal splines 101a serve to couple the output flange 101 with the input shaft 125 of the power split mechanism 4 such that power can be transmitted between the output flange 101 and the input shaft 125. Namely, external splines 125a are formed on a front end portion of the input shaft 125 of the power split mechanism 4, and the output flange 101 is arranged to be spline-fitted on the input shaft 125.

The friction material 102 of the clutch C1 is disposed radially outside of the hydraulic actuator 103, the return spring 104, and the planetary gear unit 17a. A part of the friction material 102 is coupled to the sun gear 20 of the planetary gear unit 17a so as to rotate as a unit with the sun gear 20. Another part of the friction material 102 is coupled to the carrier 18 of the planetary gear unit 17a so as to rotate as a unit with the carrier 18. In addition, a friction material 105 of the brake B1 is disposed radially outside of the clutch C1. A part of the friction material 105 is coupled to the sun gear 20 of the planetary gear unit 17a so as to rotate as a unit with the sun gear 20. Another part of the friction material 105 is fixed to the stationary member 16 formed inside the front cover 108.

In the power transmitting apparatus TM for the hybrid vehicle according to this invention, the oil passage 116 for speed control through which engaging hydraulic pressure is supplied to the clutch C1, and the oil passage 117 for shift control through which engaging hydraulic pressure is supplied to the brake B1, are formed in the front cover 108. In the example as shown in FIG. 12, for example, the oil passage 116 for shift control is a communication hole formed by drilling or boring at three locations in the interior of the front cover 108. Similarly, the oil passage 117 for shift control is a communication hole formed by drilling or boring at three locations in the interior of the front cover 108. With the front cover 108 assembled with the MG1 cover 118 and a housing 122 which will be described later, supply oil passages 122b formed in the housing 122 are connected to the oil passage 116 for shift control and the oil passage 117 for shift control, respectively. The hydraulic pressures for controlling the clutch C1 and the brake B1 are respectively supplied, from a valve body (not shown) side provided with a hydraulic source, such as an oil pump, to the supply oil passages 122b.

In the power transmitting apparatus TM, oil passages through which the lubricating oil is supplied to the planetary gear unit 17a, the rotor 2a of the first motor-generator 2, and the power split mechanism 4, for example, are formed within the respective rotary shafts of the power transmitting apparatus TM. Namely, an oil passage 100a for supply of lubricating oil is formed around the center axis of rotation within the input shaft 100 of the transmission gear mechanism 17. Similarly, an oil passage 125b for supply of lubricating oil is formed around the center axis of rotation within the input shaft 125 of the power split mechanism 4. Similarly, an oil passage 126a for supply of lubricating oil is formed around the center axis of rotation within the output shaft 126 of the power split mechanism 4 which will be described later.

The oil passage 100a formed within the input shaft 100 communicates with an oil passage 100b and an oil passage 100c which are formed through between the oil passage 100a and the outer periphery of the input shaft 100. The oil passage 100b is arranged to allow hydraulic pressure for lubrication to be supplied to a sliding portion between the input shaft 100 and the inner periphery of the front cover 108 and a sleeve 111. The oil passage 100c is arranged to allow hydraulic pressure for lubrication to be supplied to the planetary gear unit 17a of the transmission gear mechanism 17, etc.

The oil passage 125b formed within the input shaft 125 communicates with an oil passage 125c, oil passage 125d, and an oil passage 125e which are formed through between the oil passage 125b and the outer periphery of the input shaft 125. The oil passage 125c is arranged to allow hydraulic pressure for lubrication to be supplied to a sliding portion between the input shaft 125 and the inner periphery of the rotor 2a of the first motor-generator 2. The oil passage 125d is arranged to allow hydraulic pressure for lubrication to be supplied to the planetary gear unit of the power split mechanism 4, etc. The oil passage 125e is arranged to allow hydraulic pressure for lubrication to be supplied to a sliding portion between the input shaft 125 and the inner periphery of a flange 127 of the power split mechanism 4 which will be described later.

Thus, the oil passages for allowing supply of the hydraulic pressure for lubrication are formed within the respective rotary shafts of the power transmitting apparatus TM. On the other hand, the oil passages 116, 117 for shift control through which the hydraulic pressure for shift control of the transmission gear mechanism 17 are not formed within the respective rotary shafts of the power transmitting apparatus TM, but formed in the interior of the front cover 108 as described above. Accordingly, in the power transmitting apparatus TM of this invention, the oil passages formed within the rotary shafts are exclusively used for hydraulic oil for lubrication having a lower pressure that of the hydraulic oil for shift control. As a result, the arrangement of the oil passages within the rotary shafts, and the oil passages through which the lubricating oil is supplied from within the rotary shafts to respective parts of the system is simplified, as compared with the arrangement in which the oil passages that allow supply of the hydraulic pressure for shift control are provided within the rotary shafts. For example, the strength of seal rings (not shown) used for preventing hydraulic leak is reduced, or the number of locations where the seal rings are used is reduced. As the oil passages for shift control are not provided in the rotary shafts, the number of locations where the seal rings are used is surely reduced. Therefore, the dragging loss that appears at sliding portions of the seal ring during rotation of the rotary shafts can be reduced.

The constituent members, such as the planetary gear unit 17a, clutch C1, brake B1, and the input shaft 100, of the transmission gear mechanism 17 are housed and mounted inside the front cover 108. With these members constituting the transmission gear mechanism 17 thus mounted in position, the MG1 cover 118 is mounted to a rear opening portion of the front cover 108. For example, as shown in FIG. 12, the front cover 108 and the MG1 cover 118 are fixed integrally, by means of a plurality of bolts 119. The MG1 cover 118 is formed with a through-hole 118a similar to the through-hole 108a of the front cover 108. The input shaft 100 of the transmission gear mechanism 17 and the input shaft 125 of the power split mechanism 4 (which will be described later) are connected in the through-hole 118a such that the input shafts 100, 125 can rotate relative to each other. Also, the output flange 101 of the transmission gear mechanism 17 is arranged to be spline-fitted on the input shaft 125 of the power split mechanism 4.

The MG1 cover 118 as described above is formed along the shape of a front end portion (on the left-hand side in FIG. 12) of the first motor-generator 2. Therefore, a radially outer portion of the MGI cover 118 is formed in accordance with the position of a front end portion of a coil end 2b of the first motor-generator 2, whereas a central portion of the MG1 cover 118 in which the through-hole 118a is formed is shaped to be located radially inside of the coil end 2b and a stator 2c. Namely, as shown in the cross-sectional view of FIG. 12, the central portion of the MG1 cover 118 is shaped so as to protrude rightward in FIG. 12, so that the through-hole 118a is located in a radially inner portion of the first motor-generator 2. Accordingly, the output flange 101 of the transmission gear mechanism 17 and the input shaft 125 of the power split mechanism 4 are coupled to each other via splines, in the radially inner portion of the first motor-generator 2.

Thus, in the power transmitting apparatus TM according to this invention, the space in the radially inner portion of the first motor-generator 2 is effectively utilized for placement of the transmission gear mechanism 17 and the power split mechanism 4 as described above. Therefore, the overall length of the power transmitting apparatus TM as measured in the direction of its rotational axis can be shortened, and the size and weight of the power transmitting apparatus TM can be reduced.

In the example as shown in FIG. 12, space 108b is formed between the outer periphery of the stationary member 16 to which the friction material 105 of the brake B1 is fixed, and the inner periphery of the front cover 108. This space 108b effectively functions as an oil return or oil reservoir for oil supplied to the transmission gear mechanism 17.

A ball bearing 120 for supporting a front end portion (on the left-hand side in FIG. 12) of the rotor 2a of the first motor-generator 2 is mounted on a rear-side (the right-hand side in FIG. 12) surface of the MG1 cover 118. More specifically, an outer race 120a of the ball bearing 120 is fixed to the MG1 cover 118. Then, the MG1 cover 118 fixed integrally with the front cover 108 is mounted to the housing 122 in which the first motor-generator 2 (which will be described later) is housed, so that the rotor 2a is assembled with the inner race 120b of the ball bearing 120. Also, a rear end portion (on the right-hand side in FIG. 12) of the rotor 2a is supported by a ball bearing 124 which will be described later.

As described above, the transmission gear mechanism 17 is formed as one unit in a condition where the respective members, such as the planetary gear unit 17a, clutch C1, brake B1 and the input shaft 100, which constitute the transmission gear mechanism 17 are incorporated inside the front cover 108, and covered with the MG1 cover 118 as a lid. Namely, the transmission gear mechanism 17 of this invention can be formed as a transmission gear unit covered with the front cover 108 and the MG1 cover 118, and the transmission gear unit can be handled as a sub-assembly.

The housing 122 in which the first motor-generator 2, a resolver 121, etc. are housed is disposed in the rear of the front cover 10 and MG cover 118 in which the transmission gear mechanism 17 is housed. Namely, the front cover 108 and MG1 cover 118 which house the transmission gear mechanism 17 therein to form the transmission gear unit as described above are fixed to the front (the left-hand side in FIG. 12) of the housing 122. For example, the front cover 108 and the MG1 cover 118 are fixed integrally with the housing 122, by means of a plurality of bolts 123, as shown in FIG. 12.

The housing 122 is open frontward, namely, toward the MG1 cover 118 (on the left-hand side in FIG. 12), and the resolver 121 is mounted on the inner side of a rear side wall portion 122a of the housing 122. A through-hole is formed in the side wall portion 122a, and the ball bearing 124 is mounted in an inner circumferential portion of the through-hole. The stator 2c of the first motor-generator 2 is fixed inside the housing 122 in front of the resolver 121.

The rotor 2a of the first motor-generator 2 is inserted in a radially inner portion of the stator 2c. With the housing 122 assembled integrally with the front cover 108 and the MG1 cover 118, the front end portion (on left-hand side in FIG. 12) of the rotor 2a is supported by the MG1 cover 118 via the ball bearing 120, as described above. On the other hand, the rear end portion (on the right-hand side in FIG. 12) of the rotor 2a is supported by the housing 122 via the ball bearing 124. Internal splines 2d are formed in the rear end portion of the rotor 2a. The internal splines 2d are used for coupling the rotor 2a with the sun gear 6 of the power split mechanism 4 such that dynamic power can be transmitted therebetween. Namely, external splines 127a are formed on a flange 127 coupled integrally with the sun gear 6 of the power split mechanism 4 as described later, and the rotor 2a is spline-fitted on the flange 127.

The power split mechanism 4 is disposed inside the housing 122 in which the first motor-generator 2 is housed. The power split mechanism 4 is constituted by the single pinion type planetary gear unit as described above, and includes the input shaft 125 to which the carrier 8 is coupled so as to rotate as a unit with the input shaft 125, and the output shaft 126 to which the ring gear 7 is coupled so as to rotate as a unit with the output shaft 126. The flange 127 is coupled to the sun gear 6 of the power split mechanism 4 so as to rotate as a unit with the sun gear 6. The external splines 127a are formed on the outer periphery of the front end portion (on the left-hand side in FIG. 12) of the flange 127. The flange 127, and the rotor 2a of the first motor-generator 2 formed with the internal splines 2d are arranged to be spline-fitted on each other. Namely, the sun gear 6 of the power split mechanism 4 is splined to the rotor 2a of the first motor-generator 2 so that the sun gear 6 and the rotor 2a rotate as a unit.

The input shaft 125 is inserted in radially inner portions of the sun gear 6 and the flange 127, such that the sun gear 6 of the power split mechanism 4 and the flange 127 can rotate relative to each other. A front portion (on the left-hand side in FIG. 12) of the input shaft 125 protrudes from the flange 127, and the portion of the input shaft 125 protruding from the flange 127 is inserted through a radially inner portion of the rotor 2a so as to be rotatable relative to the rotor 2a. Also, the external splines 125a are formed on the outer periphery of the front end portion of the input shaft 125. Thus, the input shaft 125, and the output flange 101 of the transmission gear mechanism 17 formed with the internal splines 101a, are spline-fitted on each other. Namely, the output flange 101 as the output member of the transmission gear mechanism 17 and the input shaft 125 as the input member of the power split mechanism 4 are splined to each other so as to rotate as a unit. In this connection, serration, rather than splines, may be used for coupling the output flange 101 with the input shaft 125.

Furthermore, the countersunk hole is formed in a front end portion of the input shaft 125. The countersunk hole is used for supporting a rear end portion (on the right-hand side in FIG. 12) of the input shaft 100 of the transmission gear mechanism 17 so that the input shaft 100 and the input shaft 125 can rotate relative to each other. The bush 128 is provided between the rear end portion of the input shaft 100 and the countersunk hole formed in the front end portion of the input shaft 125.

A flange 129 that rotates as a unit with the output shaft 126 is formed on a front end portion (on the left-hand side in FIG. 12) of the output shaft 126, and the ring gear 7 of the power split mechanism 4 is coupled to the flange 129 so as to rotate as a unit with the flange 129. Namely, the output shaft 126 and the ring gear 7 are coupled to each other so as to rotate as a unit. On the other hand, a rear end portion (on the right-hand side in FIG. 12) of the output shaft 126 is coupled to the propeller shaft 9 which is not illustrated in FIG. 12 so as to rotate as a unit with the propeller shaft 9. The rear portion of the output shaft 126 is supported by a rear cover 130 mounted on the rear side of the housing 122. Namely, a through-hole is formed in a front side wall portion 130a of the rear cover 130, and the rear portion of the output shaft 126 is inserted in the through-hole of the side wall portion 130a. Thus, the output shaft 126 is supported by the inner circumferential wall of the through-hole of the side wall portion 130a.

Furthermore, a countersunk hole is formed in the front end portion of the output shaft 126. The countersunk hole is used for supporting a rear end portion (on the right-hand side in FIG. 12) of the input shaft 125 of the power split mechanism 4 such that the input shaft 125 and the output shaft 126 are rotatable relative to each other. A bush 131 is provided between the rear end portion of the input shaft 125, and the countersunk hole formed in the front end portion of the output shaft 126.

In the example as described above, the ring gear 7 of the power split mechanism 4 is coupled to the propeller shaft 9 via the output shaft 126, namely, the power transmitting apparatus TM of this invention is used in the drive train suitable for installation on the FR-type vehicle as shown in FIG. 1. On the other hand, if the power transmitting apparatus TM of this invention is used in the drive train suitable for installation on the FF-type vehicle as shown in FIG. 2, the ring gear 7 of the power split mechanism 4 is coupled to the drive gear 25 that constitutes the gear train 12, via the output shaft 126, so as to rotate as a unit with the drive gear 25. The other portions of the power transmitting apparatus TM are constructed similarly to those of the example as shown in FIG. 12.

FIG. 13 shows another example of power transmitting apparatus according to this invention. The power transmitting apparatus TM shown in FIG. 13 corresponds to the arrangement of the drive trains as shown in FIG. 10 and FIG. 11. Namely, the transmission gear mechanism 17 is constituted by the double pinion type planetary gear unit 17b.

In FIG. 13, the power transmitting apparatus TM includes the transmission gear mechanism 17, first motor-generator 2, and the power split mechanism 4, as in the arrangement shown in FIG. 12. The transmission gear mechanism 17, first motor-generator 2, and the power split mechanism 4 are arranged in the order of description, as viewed from the side closer to the engine 1 (not shown in FIG. 13), namely, as viewed from the front side (the left-hand side in FIG. 13) of the power transmitting apparatus TM.

In the arrangement shown in FIG. 13, the transmission gear mechanism 17 consists of the double pinion type planetary gear unit 17b, clutch C1 and brake B1, input shaft 200, and an intermediate shaft 201. The clutch C1 includes a friction material 202 for coupling the sun gear 33 and the carrier 32 of the planetary gear unit 17b, and a hydraulic actuator 203 and a return spring 204 that operate the friction material 202 so as to bring the clutch C1 into the engaged or released state. In operation, hydraulic pressure for engaging the clutch C1 is supplied to the hydraulic actuator 203, via an oil passage 218 for shift control, which will be described later. On the other hand, the brake B1 includes a friction material 205 for fixing the sun gear 33 of the planetary gear unit 17b in a non-rotatable condition, and a hydraulic actuator 206 and a return spring 207 that operate the friction material 205 so as to bring the brake B1 into the engaged or released state. In operation, hydraulic pressure for engaging the brake B1 is supplied to the hydraulic actuator 206, via an oil passage 219 for shift control, which will be described later.

A front cover 208 is provided for housing the above-described planetary gear unit 17b, clutch C1 and brake B1, and the input shaft 200. The front cover 208 covers a portion of the power transmitting apparatus TM which is opposed to the engine 1 in a condition where the assembling of the system TM is completed. In the power transmitting apparatus TM shown in FIG. 13, the planetary gear unit 17b, clutch C1 and brake B1, input shaft 200, and the intermediate shaft 201 are incorporated inside the front cover 208.

More specifically, the planetary gear unit 17b is mounted in a front part of the inside of the front cover 208, namely, on the side (the left-hand side in FIG. 13) closer to the engine 1 that is not shown in FIG. 13. The input shaft 200 that functions as an input member of the transmission gear mechanism 17 is disposed radially inside of the sun gear 33 of the planetary gear unit 17b, such that the input shaft 200 is rotatable relative to the sun gear 33 and the intermediate shaft 201. The input shaft 200 is supported by a needle bearing 209 provided in an inner circumferential portion of a through-hole 208a formed in the front cover 208, and a bush 210 provided in an inner circumferential portion of the intermediate shaft 201 which will be described later. The hydraulic actuator 203 and the return spring 204, and the hydraulic actuator 206 and the return spring 207, are mounted at the rear (the right-hand side in FIG. 12) of the planetary gear unit 17b.

The input shaft 200 is formed with a flange 211 that rotates as a unit with the input shaft 200, and the ring gear 31 of the planetary gear unit 17b is coupled to the flange 211 so as to rotate as a unit with the flange 211. Namely, the input shaft 200 and the ring gear 31 are coupled to each other so as to rotate as a unit. A front end portion (on the left-hand side in FIG. 13) of the input shaft 200 protrudes from the through-hole 208a, so that the input shaft 200 and the output shaft 1a of the engine 1 are coupled to each other via a damper mechanism (not shown), or the like. A rear end portion (on the right-hand side in FIG. 13) of the input shaft 200 is supported by the intermediate shaft 201 as will be described later. A portion of the input shaft 200 located at the rear of the flange 211 has a smaller outside diameter than the other portion, so that it can be inserted into a countersunk hole formed in the intermediate shaft 201.

The intermediate shaft 201 that functions as an output member of the transmission gear mechanism 17, in addition to the input shaft 200, is disposed radially inside of the sun gear 33 of the planetary gear unit 17b, such that the intermediate shaft 201 is rotatable relative to the input shaft 200 and the sun gear 33. Also, the intermediate shaft 201 is located on the rear side of the input shaft 200, on the same rotational axis as the input shaft 200. The intermediate shaft 201 is supported by a needle bearing 215 provided in an inner circumferential portion of a through-hole 217a formed in an MG1 cover 217 which will be described later, and a needle bearing 216 provided on the inner periphery of the rotor 2a of the first motor-generator 2.

The carrier 32 of the planetary gear unit 17b is coupled to the intermediate shaft 201 so as to rotate as a unit with the shaft 201. Also, a countersunk hole for supporting the rear small-diameter portion of the input shaft 200 is formed in a front end portion of the intermediate shaft 201, such that the input shaft 200 and the intermediate shaft 201 can rotate relative to each other. The bush 210 is provided between the rear end portion of the input shaft 200, and the countersunk hole formed in the front end portion of the intermediate shaft 201. Internal splines 201a are formed in a rear end portion of the intermediate shaft 201. The internal splines 201a are used for coupling the intermediate shaft 201 with the input shaft 125 of the power split mechanism 4 such that dynamic power can be transmitted therebetween. Namely, external splines 125a are formed on a front end portion of the input shaft 125 of the power split mechanism 4, and the intermediate shaft 201 and the input shaft 125 are spline-fitted on each other. Accordingly, the intermediate shaft 201 as the output member of the transmission gear mechanism 17 and the input shaft 125 as the input member of the power split mechanism 4 are splined to each other so as to rotate as a unit. In this connection, serration, rather than splines, may be used for coupling the intermediate shaft 201 with the input shaft 125.

The friction material 202 of the clutch C1 is disposed radially outside of the hydraulic actuator 203 and the return spring 204, and the planetary gear unit 17b. A part of the friction material 202 is coupled to the sun gear 33 of the planetary gear unit 17b so as to rotate as a unit with the sun gear 33. Another part of the friction material 202 is coupled to the carrier 32 of the planetary gear unit 17b so as to rotate as a unit with the carrier 32. Furthermore, a friction material 205 of the brake B1 is disposed radially outside of the clutch C1. A part of the friction material 205 is fixed to the stationary member 16 formed inside the MG1 cover 217.

The constituent members, such as the planetary gear unit 17b, clutch C1, brake B1, input shaft 200, and the intermediate shaft 201, of the transmission gear mechanism 17 are housed and mounted within the front cover 208. With these members constituting the transmission gear mechanism 17 thus mounted in position, the MG1 cover 217 is mounted to a rear opening portion of the front cover 208. For example, as shown in FIG. 13, the front cover 208 and the MG1 cover 217 are fixed integrally to each other, by means of a plurality of bolts 119. The MG1 cover 217 is formed with a through-hole 217a similar to the through-hole 208a of the front cover 208. The intermediate shaft 201 is inserted in the through-hole 217a. The rear end portion of the intermediate shaft 201 which is formed with the internal splines 201a protrudes rearward from the through-hole 217a, so as to be spline-fitted on the input shaft 125 of the power split mechanism 4, in a radially inner portion of the rotor 2a of the first motor-generator 2.

The MG1 cover 217 as described above is formed along the shape of a front end portion (on the left-hand side in FIG. 12) of the first motor-generator 2. Therefore, a radially outer portion of the MG1 cover 217 is formed in accordance with the position of a front end portion of a coil end 2b of the first motor-generator 2, whereas a central portion of the MG1 cover 217 in which the through-hole 217a is formed is shaped to be located radially inside of the coil end 2b and a stator 2c. Namely, as shown in the cross-sectional view of FIG. 13, the central portion of the MG1 cover 217 is shaped so as to protrude rightward in FIG. 13, so that the through-hole 217a is located in a radially inner portion of the first motor-generator 2. Accordingly, the intermediate shaft 201 of the transmission gear mechanism 17 and the input shaft 125 of the power split mechanism 4 are coupled to each other via splines, in the radially inner portion of the first motor-generator 2.

In the example shown in FIG. 13, too, in the power transmitting apparatus TM according to this invention, the space in the radially inner portion of the first motor-generator 2 is effectively utilized for placement of the transmission gear mechanism 17 and the power split mechanism 4, as in the above-described example shown in FIG. 12. Therefore, the overall length of the power transmitting apparatus TM as measured in the direction of its rotational axis can be shortened, and the size and weight of the power transmitting apparatus TM can be reduced.

In the power transmitting apparatus TM for the hybrid vehicle according to this invention as shown in FIG. 13, the oil passage 218 for shift control through which engaging hydraulic pressure is supplied to the clutch C1, and the oil passage 219 for shift control through which engaging hydraulic pressure is supplied to the brake B1, are formed in the MG1 cover 217. The oil passage 218 for shift control is formed by fixing a tubular member formed in a given shape in accordance with the shape of the MG1 cover 217, to an inner side surface (on the left-hand side in FIG. 13) of the MG1 cover 217, or holding the tubular member thereon. The oil passage 218 for shift control may be formed by subjecting a pipe made of a metal to a bending process for plastic deformation of the pipe. On the other hand, the oil passage 219 for shift control is a communication hole formed by boring or drilling at three locations within the front cover 208. With the front cover 208 assembled with the MG1 cover 217 and the housing 122, supply oil passages 122b formed in the housing 122 are connected to the oil passage 218 for shift control and the oil passage 219 for shift control, respectively. Hydraulic pressures for controlling the clutch C1 and the brake B1 are respectively supplied, from a valve body (not shown) side provided with a hydraulic source, such as an oil pump, to the supply oil passages 122b.

In the power transmitting apparatus TM as shown in FIG, 13, too, oil passages through which the lubricating oil is supplied to the planetary gear unit 17b, the rotor 2a of the first motor-generator 2, and the power split mechanism 4, for example, are formed within the respective rotary shafts of the power transmitting apparatus TM. Namely, an oil passage 200a for use in supply of lubricating oil is formed around the center axis of rotation of the input shaft 200 of the transmission gear mechanism 17. Similarly, an oil passage 201b for use in supply of lubricating oil is formed around the center axis of rotation of the intermediate shaft 201 of the transmission gear mechanism 17. Similarly, an oil passage 125b for use in supply of lubricating oil is formed around the center axis of rotation of the input shaft 125 of the power split mechanism 4. Similarly, an oil passage 126a for use in supply of lubricating oil is formed around the center axis of rotation of the output shaft 126 of the power split mechanism 4.

The oil passage 200a formed within the input shaft 200 communicates with an oil passage 200b and an oil passage 200c which are formed through between the oil passage 200a and the outer periphery of the input shaft 200. The oil passage 200b is arranged to allow hydraulic pressure for lubrication to be supplied to a sliding portion between the input shaft 200 and the front cover 108. The oil passage 200c is arranged to allow hydraulic pressure for lubrication to be supplied to a sliding portion between the input shaft 200 and the inner periphery of the intermediate shaft 201 that supports the input shaft 200.

The oil passage 201b formed within the intermediate shaft 201 communicates with an oil passage 201c and an oil passage 201d which are formed through between the oil passage 201b and the outer periphery of the intermediate shaft 201. The oil passage 201c is arranged to allow hydraulic pressure for lubrication to be supplied to the planetary gear unit 17b of the transmission gear mechanism 17, etc. The oil passage 201d is arranged to allow hydraulic pressure for lubrication to be supplied to sliding portions between the intermediate shaft 201, and the inner peripheries of the MG1 cover 217 and the rotor 2a of the first motor-generator 2.

The oil passage 125b formed within the input shaft 125 communicates with an oil passage 125d and an oil passage 125e which are formed through between the oil passage 125b and the outer periphery of the input shaft 125. The oil passage 125d is arranged to allow hydraulic pressure for lubrication to be supplied to the planetary gear unit of the power split mechanism 4, etc. The oil passage 125e is arranged to allow hydraulic pressure for lubrication to be supplied to a sliding portion between the input shaft 125 and the inner periphery of a flange 127 of the power split mechanism 4 which will be described later.

Thus, in the power transmitting apparatus TM as shown in FIG. 13, too, the oil passages used for supplying the hydraulic pressure for lubrication are formed within the respective rotary shafts of the power transmitting apparatus TM. On the other hand, the oil passages 218, 219 for shift control used for supplying the hydraulic pressure for shift control of the transmission gear mechanism 17 are not formed within the respective rotary shafts of the power transmitting apparatus TM, but formed along the MG1 cover 217 or formed in the interior of the MG1 cover 217 as described above. Accordingly, in the power transmitting apparatus TM of this invention, the oil passages formed within the rotary shafts are exclusively used for hydraulic oil for lubrication having a lower pressure than the hydraulic pressure for shift control. Therefore, the arrangement of the oil passages within the rotary shafts, the oil passages through which the lubricating oil is supplied from within the rotary shafts to respective parts of the system, etc., is simplified, as compared with the arrangement in which the oil passages used for supplying the hydraulic pressure for shift control are provided within the rotary shafts. For example, the strength of seal rings (not shown) used for preventing hydraulic leak is reduced, or the number of locations where the seal rings are used is reduced. As the oil passages for shift control are not provided in the rotary shafts, the number of locations where the seal rings are used is surely reduced.

A ball bearing 120 for supporting a front end portion (on the left-hand side in FIG. 13) of the rotor 2a of the first motor-generator 2 is mounted on a rear side face (on the right-hand side in FIG. 13) of the MG1 cover 217. More specifically, an outer race 120a of the ball bearing 120 is fixed to the MG1 cover 217. When the MG1 cover 217 fixed integrally with the front cover 208 is mounted to the housing 122 in which the first motor-generator 2 is housed, a part of the rotor 2a is embedded in an inner race 120b of the ball bearing 120.

As described above, the transmission gear mechanism 17 is formed as one unit in a condition where the respective members, such as the planetary gear unit 17b, clutch C1, brake B1, input shaft 200 and the intermediate shaft 201, which constitute the transmission gear mechanism 17 are incorporated inside the front cover 208, and covered with the MG1 cover 217 as a lid. Namely, the transmission gear mechanism 17 of this invention can be formed as a transmission gear unit covered with the front cover 208 and the MG1 cover 217, and the transmission gear unit can be handled as a sub-assembly.

The housing 122 in which the first motor-generator 2, resolver 121, etc. are housed is disposed in the rear of the front cover 208 and MG1 cover 217 in which the transmission gear mechanism 17 is housed. Namely, the front cover 208 and MG1 cover 217 in which the transmission gear mechanism 17 is housed to provide the transmission gear unit as described above are fixed to the front (the left-hand side in FIG. 12) of the housing 122. For example, the front cover 208 and the MGI cover 217 are fixed integrally with the housing 122, by means of a plurality of bolts 123, as shown in FIG. 13. The arrangement in the rear of the front cover 208 and the MG1 cover 217, namely, the arrangement that extends rearwards from the housing 122, is substantially the same as the arrangement shown in FIG. 12.

The procedure of assembling the power transmitting apparatus TM as shown in FIG. 12 or FIG. 13 will be described. Initially, the ball bearing 124 and the resolver 121 are mounted inside the housing 122. Then, the stator 2c of the first motor-generator 2 is mounted in position. Then, the rotor 2a of the first motor-generator 2 is built in a radially inner portion of the stator 2c.

Separately from assembling of the resolver 121 and the first motor-generator 2 with the housing 122 as described above, the transmission gear unit is assembled. Namely, the clutch C1 and the brake B1 are mounted inside the front cover 108. Then, the planetary gear unit 17a, the input shaft 100, and the output flange 101 are mounted in position. Then, the MG1 cover 118 is mounted to the front cover 108 such that the front cover 108 is lid by the MG1 cover 118. In the example of FIG. 13, the planetary gear unit 17b, the input shaft 200, and the intermediate shaft 201 are mounted inside the front cover 208. Then, the clutch C1 and the brake B1 are mounted in position. Then, the MGI cover 217 is mounted to the front cover 208 such that the front cover 208 is lid by the MG1 cover 217. In this manner, the transmission gear mechanism 17, which is covered with the front cover 208 and the MG1 cover 217, is assembled as the transmission gear unit.

The transmission gear unit, namely, the transmission gear mechanism 17 mounted inside the front cover 108 and the MG1 cover 118 or inside the front cover 208 and the MG1 cover 217, is mounted to the housing 122 in which the resolver 121, the first motor-generator 2, etc. are incorporated. Namely, the transmission gear unit incorporating the transmission gear mechanism 17 is mounted on the left-hand side of the housing 122 as viewed in FIG. 12 or FIG. 13.

As described above, in the power transmitting apparatus TM according to this invention, the transmission gear unit is mounted to the housing 122, so that the oil passages 116, 117 for shift control, or the oil passages 218, 219 for shift control, are connected to the supply oil passage 122b formed in the housing 122. Accordingly, with the transmission gear unit incorporating the transmission gear mechanism 17 thus mounted to the housing 122 as described above, the oil passages 116, 117 for shift control, or the oil passages 218, 219 for shift control, are brought into communication with the supply oil passage 122b of the housing 122, and the hydraulic pressure for shift control, which is supplied from a hydraulic source, can be supplied to the hydraulic actuators 103, 106 or the hydraulic actuators 203, 206 of the transmission gear mechanism 17, through the supply oil passage 122b, and the oil passages 116, 117 for shift control or the oil passages 218, 219 for shift control.

In the condition where the transmission gear unit is mounted to the housing 122 as described above, an inspection of the first motor-generator 2 can be conducted. More specifically, a dummy shaft (not shown) on which external splines similar to the external splines 127a are formed is used in place of the flange 127 of the power split mechanism 4 on which the external splines 127a are formed, and the dummy shaft is fitted in the internal splines 2d formed in the rear end portion (on the right-hand side in FIG. 12 and FIG. 13) of the rotor 2a of the first motor-generator 2. Then, the dummy shaft is connected to a certain measurement instrument, and the first motor-generator 2 is test-driven, so that the operation of the first motor-generator 2 can be easily checked, and the resolver 121, etc. can be easily adjusted.

Subsequently, the power split mechanism 4 is mounted to the housing 122 to which the transmission gear unit is mounted. More specifically, the power split mechanism 4 is mounted from the right-hand side (in FIG. 12 or FIG. 13) of the housing 122. The power split mechanism 4 is assembled in advance, by mounting the input shaft 125, flange 127, output shaft 126, etc. on the planetary gear unit. The input shaft 125 of the power split mechanism 4 is inserted into the radially inner portion of the rotor 2a of the first motor-generator 2 mounted in the housing 122. Then, the external splines 125a formed on the input shaft 125 and the internal splines 101a formed in the output flange 101 of the transmission gear mechanism 17 are splined to each other. In the example shown in FIG. 13, the external splines 125a formed on the input shaft 125 and the internal splines 201a formed in the intermediate shaft 201 of the transmission gear mechanism 17 are splined to each other. Namely, the output member of the transmission gear mechanism 17 and the input member of the power split mechanism 4 are coupled to each other via splines.

Then, the rear cover 130 is mounted to a rear end portion of the housing 122. With the rear cover 130 thus mounted to the housing 122, the output shaft 126 of the power split mechanism 4 is supported, and assembling of the power transmitting apparatus TM is completed.

As described above, in the power transmitting apparatus TM according to this invention, the transmission gear mechanism 17 that changes the rotational speed of the engine 1 by hydraulically controlling the clutch C1 and the brake B1 is provided between the engine 1 and the power split mechanism 4. The transmission gear mechanism 17 is formed as an integral transmission gear unit that is housed inside the front cover 108 and the MG1 cover 118, or inside the front cover 208 and the MG1 cover 217, relative to the housing 122 as a principal part of the power transmitting apparatus TM in which the power split mechanism 4 and the first motor-generator 2 are housed. Accordingly, the transmission gear mechanism 17 including the clutch C1 and the brake B1 can be handled as a sub-assembly.

In the power transmitting apparatus TM according to this invention, the oil passages 116, 117 used for supplying hydraulic pressure to the hydraulic actuators 103, 106 for hydraulic control of the transmission gear mechanism 17 are provided by communication holes formed by boring or drilling in the interior of the front cover 108, for example. In the example shown in FIG. 13, the oil passage 219 is provided by a communication hole formed by boring or drilling in the interior of the MG1 cover 217. In the same example, the oil passage 218 is formed in a metal pipe formed by bending along the shape of the MG1 cover 217. The above-described oil passages 116, 117, 218, 219 are arranged to communicate with the supply oil passage 122b formed in the housing 122, no matter how each oil passage is formed, in a condition where the transmission gear unit including the transmission gear mechanism 17 is mounted to the housing 122. Therefore, the hydraulic pressure for shift control is supplied to the transmission gear mechanism 17, via the supply oil passage 122b of the housing 122, and the oil passages 116, 117 for shift control or the oil passages 218, 219 for shift control.

Thus, in the power transmitting apparatus TM according to the invention, the oil passages 116, 117, 218, 219 for shift control through which the hydraulic pressure for shift control is supplied are not formed within the rotary shafts of the power transmitting apparatus TM, but formed in the front cover 108 or the MG1 cover 217. Therefore, the oil passages formed within the rotary shafts as in the known system may be used exclusively for hydraulic oil for lubrication having a lower pressure than the control hydraulic pressure. Consequently, the arrangement of the oil passages formed within the rotary shafts can be simplified. Also, since the oil passages 116, 117, 218, 219 for shift control are formed in the front cover 108 or the MG1 cover 217, the number of locations where seal rings are used can be reduced. Therefore, the dragging loss that would appear in sliding portions of the seal rings during rotation of the rotary shafts can be reduced. Consequently, the energy efficiency of the power transmitting apparatus TM can be improved.

In the above-described specific examples, the so-called two-motor-type hybrid vehicle, which includes the engine 1, and the first motor-generator 2 and second motor-generator 3, as sources of driving force has been described as the hybrid vehicle to which the invention is applied. However, the hybrid vehicle of the invention may include an engine, and three or more motor-generators. The hybrid vehicle of the invention may also be a plug-in hybrid vehicle having a battery that can be charged directly from an external power supply.

1. A power transmitting apparatus for a hybrid vehicle including an engine as a drive source, and a hydraulic actuator, the power transmitting apparatus comprising:
at least one rotary machine that is a drive source of the hybrid vehicle;
a power split mechanism that is a differential mechanism having a first rotation element, a second rotation element to which the rotary machine is coupled, and a third rotation element to which a drive shaft is coupled, the power split mechanism being configured to split or combine dynamic power among drive sources and the drive shaft and transmit the split or combined dynamic power to the sources of driving force or the drive shaft;
a housing in which the power split mechanism and the at least one rotary machine are disposed;
a transmission gear mechanism having a friction device that is engaged or disengaged by the hydraulic actuator, the transmission gear mechanism being configured to change a rotational speed of the engine through engagement and disengagement of the friction device, and transmit torque of the engine to the first rotation element;
a front cover that covers one side of the transmission gear mechanism closer to the engine; and
a rotary machine cover that covers the other side of the transmission gear mechanism closer to the power split mechanism, wherein
the transmission gear mechanism disposed inside the front cover,
the transmission gear mechanism is covered with the front cover and the rotary machine cover,
the transmission gear mechanism, the front cover, and the rotary machine cover are a transmission gear unit,
the transmission gear unit is provided to an end portion of the housing closer to the transmission gear mechanism,
an oil passage for shift control is provided in the front cover or the rotary machine cover, and
a hydraulic pressure is supplied to the hydraulic actuator through the oil passage for the shift control.

2. The power transmitting apparatus according to claim 1, wherein:
the friction device includes a clutch and a brake,
the transmission gear mechanism includes a single planetary gear unit,
the clutch is configured to selectively connect a sun gear of the single planetary gear unit to a carrier of the single planetary gear unit,
the brake is configured to selectively fix the sun gear so as to make the sun gear unable to rotate,
the oil passage for the shift control includes at least one of a communication hole and a tubular member,
the communication hole is provided in an interior of the front cover, and
the tubular member that is shaped along a shape of the front cover.

3. The power transmitting apparatus according to claim 1, wherein:
the friction device includes a clutch and a brake,
the transmission gear mechanism includes a double planetary gear unit,
the clutch is configured to selectively connect a sun gear of the double planetary gear unit to a carrier of the double planetary gear unit,
the brake is configured to selectively fix the sun gear so as to make the sun gear unable to rotate,
the oil passage for the shift control includes at least one of a communication hole and a tubular member,
the communication hole is provided in an interior of the rotary machine cover, and
the tubular member is shaped along a shape of the rotary machine cover.

4. The power transmitting apparatus according to claim 1, wherein
the transmission gear unit is provided to the housing such that the oil passage for the shift control is connected to a supply oil passage,
the supply oil passage is provided in the housing, and
a hydraulic pressure is supplied from a hydraulic source to the supply oil passage.

5. The power transmitting apparatus according to claim 2, wherein
the transmission gear unit is provided to the housing such that the oil passage for the shift control is connected to a supply oil passage,
the supply oil passage is provided in the housing, and
a hydraulic pressure is supplied from a hydraulic source to the supply oil passage.

6. The power transmitting apparatus according to claim 3, wherein
the transmission gear unit is provided to the housing such that the oil passage for the shift control is connected to a supply oil passage,
the supply oil passage is provided in the housing, and
a hydraulic pressure is supplied from a hydraulic source to the supply oil passage.
